(19) United States
(12) Patent Application Publication
(10) Pub. No.: US 2026/0094107 A1
(43) Pub. Date: Apr. 2, 2026

(54) SYSTEM AND METHOD FOR GENERATING UNBIASED EVALUATION OF A PORTFOLIO MANAGER

(71) Applicant: Essentia Analytics Ltd, London (GB)

(72) Inventors: Christopher Woodcock, London (GB); Clare Flynn Levy, Old Greenwich, CT (US); Isaac Kelleher Unger, London (GB)

(21) Appl. No.: 18/901,816

(22) Filed: Sep. 30, 2024

(51) Int. Cl. G06Q 10/0639; G06Q 40/06

(52) U.S. Cl. CPC G06Q 10/06398; G06F 17/18; G06Q 40/06

(57) ABSTRACT

A method for generating an unbiased evaluation of a portfolio manager. The method includes receiving holdings data of the portfolio manager, detecting one or more decisions from the holdings data corresponding to changes in quantity of an instrument, and generating episode data from the holdings data based on the decisions and a machine learning algorithm. A decision type is determined for the decisions based on a phase identifier and a time window. Value added metrics for the portfolio manager are calculated based on the episode data and the decision type using a machine learning algorithm. The method further includes calculating decision metrics for the decisions, including at least one of hit-rate, payoff, and BA score. The disclosed method enables objective evaluation of portfolio manager performance based on decision-making skills rather than solely on investment outcomes.

### FIELD OF INVENTION

The present disclosure relates to systems and methods for evaluating investment performance, and more particularly to a system and method for generating unbiased rankings of portfolio managers based on decision-making skill rather than past performance.

### BACKGROUND

Portfolio managers face significant technical challenges in accurately evaluating their decision-making skills across multiple investment types and time horizons. Traditional performance assessment methods using traditional software often fail to distinguish between the effects of a manager's skill and market luck, leading to potentially inaccurate evaluations of portfolio management expertise.

Portfolio performance is typically evaluated based on overall returns compared to relevant benchmarks by the traditional software. This approach relies heavily on aggregate metrics and often overlooks the granular details of individual investment decisions. Some advanced methods attempt to decompose performance into various factors, but these still struggle to isolate the impact of specific decision types such as entry timing, scaling, and exit strategies.

Existing solutions face several limitations. First, they often lack the ability to adapt to changing market conditions, potentially misattributing performance in volatile or rapidly evolving markets. Second, current methods typically do not provide detailed feedback on specific decision types, hindering targeted skill improvement. Finally, these approaches often fail to account for the complex, multi-dimensional nature of investment decisions, potentially overlooking important aspects of a portfolio manager's skill set. As a result, there is a pressing need for a more sophisticated, data-driven approach to evaluating portfolio manager performance that can overcome these technical challenges.

### SUMMARY

Before the present system(s) and method(s), are described, it is to be understood that this application is not limited to the particular system(s), and methodologies described, as there can be multiple possible embodiments that are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for evaluating a portfolio manager. This summary is not intended to identify essential features of the claimed subject matter, nor is it intended for use in determining or limiting the scope of the claimed subject matter.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating an unbiased evaluation of a portfolio manager is provided. A method for generating an unbiased rank for a portfolio manager may also be provided. The method includes receiving holdings data of the portfolio manager. The method includes detecting one or more decisions from the holdings data, wherein the one or more decisions correspond to change in quantity of an instrument. The method includes generating episode data from the holdings data based on the one or more decisions and a machine learning algorithm. The method includes determining a decision type for the one or more decisions based on a phase identifier and a time window. The method includes calculating value added metrics for the portfolio manager based on the episode data and the decision type based on a machine learning algorithm. The value added metrics are calculated by: splitting the one or more decisions based on the decision type using a machine learning algorithm; determining a validation condition based on the decision type and the episode data; validating the one or more decisions based on the respective validation condition; identifying suitable value added metrics for the one or more decisions based on the decision type; and calculating the suitable value added metrics for the one or more decisions. The method includes calculating decision metrics for the one or more decisions, the decision metrics include at least one of hit-rate, payoff, and Behavioral Alpha (BA) score.

According to other aspects of the present disclosure, the method may include one or more of the following features. The decision type may be selected from a group consisting of entry timing, scaling in, stock picking, size adjusting, weighting, scaling out, and exit timing. The validation condition may include at least one of a valid start date and sufficient data within a subset. The suitable value added metrics may include at least one of value added percentage, value added percentage compounding, general impact compounding, and weighting impact compounding.

According to another aspect of the present disclosure, a system for generating an unbiased evaluation of a portfolio manager is provided. The system includes a processor and a memory storing instructions that, when executed by the processor, cause the system to receive holdings data of the portfolio manager. The system detects one or more decisions from the holdings data, wherein the one or more decisions correspond to change in quantity of an instrument. The system generates episode data from the holdings data based on the one or more decisions and a machine learning algorithm. The system determines a decision type for the one or more decisions based on a phase identifier and a time window. The system calculates value added metrics for the portfolio manager based on the episode data and the decision type using a machine learning algorithm. The system calculates decision metrics for the one or more decisions, the decision metrics including at least one of hit-rate, payoff, and Behavioral Alpha (BA) score.

According to other aspects of the present disclosure, the system may include one or more of the following features. The decision type may be selected from a group consisting of entry timing, scaling in, stock picking, size adjusting, weighting, scaling out, and exit timing. Calculating the value added metrics may comprise: splitting the one or more decisions based on the decision type using a machine learning algorithm; determining a validation condition based on the decision type and the episode data; validating the one or more decisions based on the respective validation condition; identifying suitable value added metrics for the one or more decisions based on the decision type; and calculating the suitable value added metrics for the one or more decisions. The validation condition may include at least one of a valid start date and sufficient data within a subset. The suitable value added metrics may include at least one of value added percentage, value added percentage compounding, general impact compounding, and weighting impact compounding. The system may update the decision metrics based on contextual information received regarding one or more of the decisions.

The foregoing general description of the illustrative embodiments and the following detailed description thereof are merely exemplary aspects of the teachings of this disclosure and are not restrictive.

### BRIEF DESCRIPTION OF FIGURES

The foregoing detailed description of embodiments is better understood when read in conjunction with the appended drawings. For the purpose of illustrating the present subject matter, an example of a construction of the present subject matter is provided as figures, however, the invention is not limited to the specific method and system for processing holding data of a portfolio manager disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

The figures depict an embodiment of the present disclosure for purposes of illustration only. One skilled in the art will readily recognize from the following discussion that alternative embodiments of the structures and methods illustrated herein may be employed without departing from the principles of the disclosure described herein.

FIG. 1 illustrates a system diagram of a computing system, according to aspects of the present disclosure.

FIG. 2 illustrates a flowchart for a method of generating an unbiased rank for a portfolio manager, according to an embodiment.

FIG. 3 illustrates a flowchart for a method of updating a BA score for a portfolio manager, according to aspects of the present disclosure.

FIG. 4 illustrates a flowchart for a method of calculating value added metrics for investment decisions, according to an embodiment.

FIG. 5 illustrates a system diagram of a neural network architecture, according to aspects of the present disclosure.

FIG. 6 illustrates an isometric view of a data cube, according to an embodiment.

FIG. 7A illustrates a flowchart for a method of processing and analyzing portfolio data, according to aspects of the present disclosure.

FIG. 7B illustrates flowcharts for different decision types for the method of FIG. 7A of processing and analyzing portfolio data, according to aspects of the present disclosure.

### DETAILED DESCRIPTION

Some embodiments of this disclosure, illustrating all its features, will now be discussed in detail. The words “receiving,” “detecting,” “generating,” “determining,” “calculating,” and other forms thereof, are intended to be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present disclosure provides a system and method for evaluating the performance of portfolio managers in the financial industry. This system and method focus on assessing the decision-making skill of portfolio managers, rather than relying solely on historical returns or other traditional performance metrics. This approach offers a more nuanced and accurate evaluation of a manager's abilities, taking into account the quality of individual investment decisions, the consistency of the manager's approach, and their adaptability to changing market conditions.

The disclosed system and method leverage advancements in data analytics and technology to analyze investment decisions and portfolio construction in a more sophisticated manner. They employ machine learning algorithms to detect decisions from holdings data, generate episode data, determine decision types, and calculate value added metrics for each portfolio manager. Further, the value added metrics may be used to calculate decision metrics for the portfolio manager. The decision metrics may include hit-rate, payoff, and Behavioral Alpha (BA) score.

This approach offers several advantages over traditional performance-based evaluation methods. It allows for a more accurate assessment of a manager's skill, provides insights into their decision-making processes, and offers a fairer basis for comparison across different investment styles and market conditions. Furthermore, it enables portfolio managers to actively improve their decision-making skills, thereby potentially enhancing their future performance.

In summary, the present disclosure provides a novel and effective solution to the challenges of evaluating portfolio manager performance, offering a more accurate and unbiased assessment of manager skill.

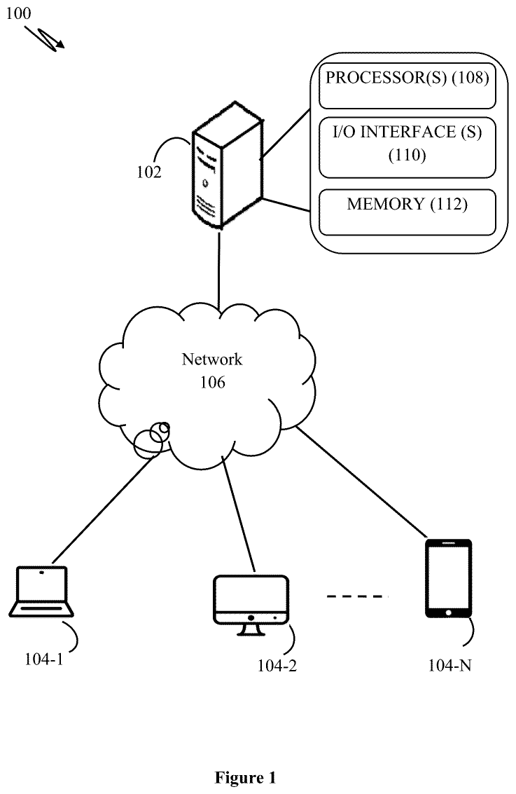

Referring to FIG. 1, a system diagram of a computing system 100 is illustrated. The system 100 includes a server 102 connected to a network 106. The server 102 comprises a processor 108, and I/O interface 110, and a memory 112. The network 106 connects the server 102 to multiple client devices, including a laptop 104-1, a desktop computer 104-2, and a mobile device 104-N.

In some aspects, the server 102 may be a standalone unit with its internal components shown. The processor 108 may be responsible for executing instructions and performing computations. The I/O interface 110 may manage input and output operations, facilitating communication between the server 102 and the network 106. The memory 112 may store data and instructions for the processor 108.

The network 106, represented as a cloud, may indicate a communication infrastructure that enables data exchange between the server 102 and the client devices. The client devices may be depicted as a laptop 104-1, a desktop computer 104-2, and a mobile device 104-N, representing various types of computing devices that can connect to the server 102 through the network 106. The use of “104-N” suggests that the system can accommodate multiple client devices of different types.

The system 100 illustrates a client-server architecture where the server 102 can process requests and provide services to the connected client devices 104-1, 104-2, and 104-N via the network 106. This architecture may be used to implement the methods described herein for evaluating the performance of portfolio managers. The server 102 may execute machine learning algorithms to analyze the holdings data, generate episode data, detect decisions, determine decision types, and calculate value added metrics. The client devices 104-1, 104-2, and 104-N may be used by portfolio managers to interact with the system 100, providing holdings data and receiving performance evaluations.

The present disclosure provides a method and system for evaluating and ranking portfolio managers in the financial services industry. This approach focuses on the decision-making skill of portfolio managers, rather than relying solely on past performance metrics. The disclosed method involves the analysis of portfolio holdings data to detect specific investment decisions and actions taken by the portfolio manager. These decisions are then categorized into distinct types, each corresponding to a different phase of the investment process.

A unique aspect of the disclosed method is the calculation of BA score for each portfolio manager, based on the quality of their decisions across different decision types and phases. This BA score is derived from a combination of decision metrics, including hit-rate and payoff which are calculated for each decision.

In some aspects value added metrics for different decision types are further cumulatively analyzed to calculate the decision metrics including the Behavioral Alpha (BA) score, which provides a comprehensive and nuanced measure of a portfolio manager's decision-making ability.

The disclosed system and method offer several potential advantages over traditional performance-based evaluation methods. By focusing on decision-making skill, the disclosed method provides a more direct and meaningful measure of a portfolio manager's competence. This approach also allows for a more detailed and granular analysis of portfolio management processes, potentially revealing specific areas of strength and weakness. Furthermore, by incorporating behavioral factors into the evaluation process, the disclosed method may provide deeper insights into the cognitive and psychological aspects of portfolio management.

In some embodiments, the disclosed method may be implemented using advanced data analytics and machine learning techniques, enabling the analysis of large datasets of portfolio holdings and transactions. This could potentially lead to more accurate and reliable rankings of portfolio managers, and ultimately, better-informed investment decisions.

In some aspects, the disclosed method may employ machine learning techniques to identify statistically significant patterns in a portfolio manager's investment behavior. This could involve training a machine learning model on historical holdings data, with the model learning to recognize and categorize different types of investment decisions based on patterns in the data. The machine learning model may be trained using a variety of algorithms, such as decision trees, neural networks, or support vector machines, depending on the specific requirements of the task.

The machine learning model may be designed to identify patterns that are indicative of good decision-making skill. For example, the model may learn to recognize patterns of decisions that consistently lead to positive investment outcomes, or patterns of decisions that are associated with a high BA Score. The model may also learn to identify patterns of decisions that are indicative of poor decision-making skill, such as patterns of decisions that consistently lead to negative investment outcomes or patterns of decisions that are associated with a low BA Score.

In some cases, the machine learning model may also be used to predict future investment outcomes based on a portfolio manager's past decision-making patterns. For example, the model may be trained to predict the likelihood of a portfolio manager achieving a high BA Score in the future based on their past decision-making patterns. This could provide valuable insights for investors and capital allocators when selecting portfolio managers.

In some embodiments, the machine learning model may be continually updated and refined as new holdings data becomes available. This could allow the model to adapt to changes in market conditions or investment strategies, ensuring that the BA Score remains a reliable and accurate measure of a portfolio manager's decision-making skill.

In some cases, the machine learning model may also be used to provide feedback to portfolio managers, helping them to improve their decision-making skills. For example, the model could identify specific areas where a portfolio manager's decision-making could be improved, and provide recommendations for how to improve in these areas. This could potentially lead to improved investment outcomes and higher BA Scores for the portfolio manager.

In some aspects, the method for generating an unbiased evaluation of a portfolio manager may involve receiving holdings data of the portfolio manager. The holdings data may include information about the portfolio manager's investment decisions over a specified period. This period may be determined based on various factors, such as the portfolio manager's investment strategy, the nature of the assets in the portfolio, or other relevant considerations.

In some cases, the holdings data may be collected for a period of three years or twelve quarters. This time frame may provide a comprehensive view of the portfolio manager's decision-making patterns and investment outcomes. The three-year or twelve-quarter period may also allow for the analysis of the portfolio manager's performance across different market conditions and economic cycles, potentially providing a more robust and reliable measure of their decision-making skill.

In other cases, the time period for which holdings data is collected may be adjusted based on specific requirements or constraints. For example, if a portfolio manager has been managing a portfolio for less than three years, the holdings data may be collected for the entire duration of their management. Alternatively, if a portfolio manager has been managing a portfolio for more than three years, the holdings data may be collected for the most recent three-year period, or for any other three-year period within their management tenure.

The holdings data may be received from various sources, such as financial databases, portfolio management systems, or directly from the portfolio manager or their organization. The data may be received in various formats, such as spreadsheets, database files, or other data file formats. The data may also be received through various channels, such as electronic data transfers, data feeds, or other data transmission methods.

Once the holdings data is received, it may be processed and analyzed to detect the portfolio manager's investment decisions and calculate their BA Score, as described in further detail below.

In some aspects, the method involves detecting one or more decisions from the holdings data, where these decisions correspond to changes in the quantity of an instrument held by the portfolio manager. The holdings data may include information about the quantity of each instrument held by the portfolio manager at different points in time. A decision may be detected when there is a change in the quantity of an instrument held by the portfolio manager. For example, a decision may be detected when the quantity of an instrument held by the portfolio manager increases, indicating that the portfolio manager has decided to buy more of that instrument. Similarly, a decision may be detected when the quantity of an instrument held by the portfolio manager decreases, indicating that the portfolio manager has decided to sell some of that instrument.

In some cases, the method may involve detecting decisions based on changes in the quantity of an instrument held by the portfolio manager over a specified time period. The time period may be determined based on various factors, such as the portfolio manager's investment strategy, the nature of the assets in the portfolio, or other relevant considerations. For example, the method may involve detecting decisions based on changes in the quantity of an instrument held by the portfolio manager over a daily, weekly, monthly, or yearly time period.

In other cases, the method may involve detecting decisions based on changes in the quantity of an instrument held by the portfolio manager that exceed a specified threshold. The threshold may be determined based on various factors, such as the volatility of the instrument, the liquidity of the instrument, the size of the portfolio, or other relevant considerations. For example, the method may involve detecting decisions based on changes in the quantity of an instrument held by the portfolio manager that exceed a threshold of a certain percentage of the total quantity of that instrument held by the portfolio manager.

In yet other cases, the method may involve detecting decisions based on changes in the quantity of an instrument held by the portfolio manager that occur in conjunction with certain events or conditions. For example, the method may involve detecting decisions based on changes in the quantity of an instrument held by the portfolio manager that occur in conjunction with significant market events, changes in the portfolio manager's investment strategy, changes in the portfolio manager's risk tolerance, or other relevant events or conditions.

In some aspects, the method involves generating episode data from the holdings data based on the detected decisions and a machine learning algorithm. The episode data may provide a detailed record of the portfolio manager's investment decisions and actions over a specified period. Each episode may correspond to a distinct investment decision or action, such as buying or selling a particular instrument, adjusting the size of a position, or timing an entry or exit. The episode data may include information about a set of decisions. The information may include the type of decision, the timing of the decision, the instrument involved, the quantity of the instrument bought or sold, and other relevant details.

In some cases, the episode data may be generated using a machine learning algorithm that is trained to recognize and categorize different types of investment decisions based on patterns in the holdings data. The machine learning algorithm may be trained using a variety of techniques, such as supervised learning, unsupervised learning, or reinforcement learning, depending on the specific requirements of the task. The machine learning algorithm may also be trained using a variety of data, such as historical holdings data, market data, or other relevant data.

In some embodiments, the machine learning algorithm may be designed to identify statistically significant patterns in the portfolio manager's investment behavior and surface those patterns in the episode data. For example, the machine learning algorithm may learn to recognize patterns of decisions that consistently lead to positive investment outcomes, or patterns of decisions that are associated with a high BA Score. The machine learning algorithm may also learn to identify patterns of decisions that are indicative of poor decision-making skill, such as patterns of decisions that consistently lead to negative investment outcomes or patterns of decisions that are associated with a low BA Score.

In some aspects, the future use of reinforcement learning may be considered to construct well-formed episodes. Reinforcement learning is a type of machine learning where an agent learns to make decisions by taking actions in an environment to achieve a goal. The agent learns from the consequences of its actions, adjusting its behavior to maximize the reward or minimize the penalty. In the context of generating episode data, a reinforcement learning model could be trained to construct well-formed episodes from holdings data based on the known good episodes in the data set. The reinforcement learning model could learn to recognize and categorize different types of investment decisions, and to construct episodes that accurately represent the portfolio manager's decision-making process. This could potentially lead to more accurate and reliable episode data, and ultimately, better-informed evaluations of portfolio managers.

In some aspects, the method involves determining a decision type for the one or more decisions based on a phase identifier and a time window. The decision type may correspond to a specific phase of the investment process, such as entry timing, scaling in, stock-picking, size adjusting, weighting, scaling out, and exit timing. Each of these decision types represents a different aspect of the portfolio manager's decision-making process and may contribute differently to the overall performance of the portfolio.

The entry timing decision type may correspond to the phase of the investment process where the portfolio manager decides when to first purchase a particular instrument. This decision type may involve considerations such as the current market conditions, the price of the instrument, the portfolio manager's investment strategy, and other relevant factors. In some cases, the entry timing decision type may be determined based on changes in the quantity of the instrument held by the portfolio manager, with an increase in quantity indicating a decision to enter a position.

The scaling in decision type may correspond to the phase of the investment process where the portfolio manager gradually increases the size of a position in a particular instrument. This decision type may involve considerations such as the performance of the instrument, the portfolio manager's confidence in the investment, the liquidity of the instrument, and other relevant factors. In some cases, the scaling in decision type may be determined based on a series of increases in the quantity of the instrument held by the portfolio manager over a specified time period.

The stock-picking decision type may correspond to the phase of the investment process where the portfolio manager selects which instruments to include in the portfolio. This decision type may involve considerations such as the potential return of the instrument, the risk associated with the instrument, the portfolio manager's investment strategy, and other relevant factors. In some cases, the stock-picking decision type may be determined based on the portfolio manager's decisions to buy or sell different instruments.

The size adjusting decision type may correspond to the phase of the investment process where the portfolio manager adjusts the size of a position in a particular instrument. This decision type may involve considerations such as the performance of the instrument, the portfolio manager's confidence in the investment, the liquidity of the instrument, and other relevant factors. In some cases, the size adjusting decision type may be determined based on changes in the quantity of the instrument held by the portfolio manager, with increases or decreases in quantity indicating decisions to adjust the size of the position.

The weighting decision type may correspond to the phase of the investment process where the portfolio manager decides how much of the portfolio's capital to allocate to a particular instrument. This decision type may involve considerations such as the potential return of the instrument, the risk associated with the instrument, the portfolio manager's investment strategy, and other relevant factors. In some cases, the weighting decision type may be determined based on the proportion of the portfolio's capital allocated to each instrument.

The scaling out decision type may correspond to the phase of the investment process where the portfolio manager gradually decreases the size of a position in a particular instrument. This decision type may involve considerations such as the performance of the instrument, the portfolio manager's confidence in the investment, the liquidity of the instrument, and other relevant factors. In some cases, the scaling out decision type may be determined based on a series of decreases in the quantity of the instrument held by the portfolio manager over a specified time period.

The exit timing decision type may correspond to the phase of the investment process where the portfolio manager decides when to sell a particular instrument. This decision type may involve considerations such as the current market conditions, the price of the instrument, the portfolio manager's investment strategy, and other relevant factors. In some cases, the exit timing decision type may be determined based on changes in the quantity of the instrument held by the portfolio manager, with a decrease in quantity indicating a decision to exit a position.

In some cases, the decision type for each decision may be determined based on a phase identifier and a time window. The phase identifier may be a label or code that indicates the phase of the investment process to which the decision corresponds. The time window may be a specified period during which the decision was made. The phase identifier and time window may be used to categorize the decisions into different decision types, facilitating the analysis of the portfolio manager's decision-making skill across different phases of the investment process.

In some aspects, the method involves determining a decision type for each of the detected decisions based on a phase identifier and a time window. The phase identifier may correspond to a specific phase of the investment process, such as entry phase, scaling in phase, coasting phase, scaling out phase, or exit phase. Each of these phases represents a different aspect of the portfolio manager's decision-making process and may contribute differently to the overall performance of the portfolio.

In some aspects, the method may include a machine learning algorithm for determining the phase identifier. The machine learning algorithm may be trained using historical holdings data of a plurality of portfolio managers and labels for identified phases in the holdings data. The machine learning algorithm may assign a phase identifier for a specific time window in the holdings data.

The entry timing phase, for instance, may correspond to the period when the portfolio manager decides when to first purchase a particular instrument. The scaling in phase may represent the period after the initial purchase when the portfolio manager gradually increases the size of the position. The stock-picking phase may correspond to the selection of specific instruments to include in the portfolio. The size adjusting phase may represent the period when the portfolio manager adjusts the size of a position in a particular instrument. The weighting phase may correspond to the decision of how much of the portfolio's capital to allocate to a particular instrument. The scaling out phase may represent the period prior to selling a position when the portfolio manager gradually decreases the size of the position. Lastly, the exit timing phase may correspond to the period when the portfolio manager decides when to sell a particular instrument.

In some cases, the time window for each decision type may be determined based on various factors, such as the portfolio manager's investment strategy, the nature of the assets in the portfolio, or other relevant considerations. For example, the time window for the entry timing phase may be determined based on the average holding period of episodes in the portfolio. Similarly, the time window for the scaling in phase may be determined based on the average holding period of episodes in the portfolio. The time window for the stock-picking phase may be determined based on the length of the episode. The time window for the size adjusting phase may be determined based on the period of the episode after the scaling in phase finishes and before the scaling out phase begins, known as the coasting phase.. Similarly, the time window for the weighting phase may be determined based on the coasting phase The time window for the scaling out phase may be determined based on the average holding period of episodes in the portfolio. The time window for the exit timing phase may be determined based on the average holding period of episodes in the portfolio.

In some embodiments, the phase identifier and the time window may be used to categorize the decisions into different decision types, facilitating the analysis of the portfolio manager's decision-making skill across different phases of the investment process. This categorization may enable a more detailed and granular analysis of the portfolio manager's decision-making process, potentially revealing specific areas of strength and weakness.

In some aspects, the method involves calculating value added metrics for the portfolio manager based on the episode data and the decision type. The value added metrics may be calculated by first splitting the decisions based on the decision type.

In some cases, the decisions may be split into different groups based on the decision type. For example, the decisions may be split into groups corresponding to entry timing decisions, scaling in decisions, stock-picking decisions, size adjusting decisions, weighting decisions, scaling out decisions, and exit timing decisions. Each group of decisions may then be analyzed separately to calculate the value added metrics for the corresponding decision type.

In some embodiments, the method may involve determining a validation condition for each group of decisions based on the decision type and the episode data. The validation condition may be a criterion or set of criteria that a decision must meet to be considered valid. For example, the validation condition for entry timing decisions may be that the holdings data comprises one or more entries for the full span of the time window under consideration. In another example, the validation condition for a scaling in decision may include a threshold number of entries after a first buy decision, a threshold number of instrument quantity added after the first entry decision, and the like.

In some cases, the decisions may be validated based on the respective validation condition. This may involve checking each decision against the validation condition for the corresponding decision type. Decisions that meet the validation condition may be considered valid and included in the calculation of the value added metrics. Decisions that do not meet the validation condition may be considered invalid and excluded from the calculation of the value added metrics.

In some aspects, the method may involve identifying suitable value added metrics for the decisions based on the decision type. The value added metrics may be measures of the economic value added by the decisions. For example, the value added metric for entry timing decisions may be the change in the price of the instrument after the decision was made. The value added metric for scaling in decisions may be the difference in the weighted average price paid compared with the average price paid under a theoretical scenario in which the holding quantity was increased linearly through the phase. The value added metric for stock-picking decisions may be the return on the investment. The value added metric for size adjusting decisions may be the return on the episode over the coasting phase compared to a theoretical episode in which the position was held at the median quantity over the same period. The value added metric for weighting decisions may be the return on the episode compared to a theoretical episode in which the portfolio weight of the episode was always equal to all other episodes on each day. The value added metric for exit timing decisions may be the increase in the price of the instrument after the decision was made. The value added metric for scaling out decisions may be the difference in the weighted average price paid compared with the average price paid under a theoretical scenario in which the holding quantity was increased linearly through the phase.

In some cases, the method may involve using a median absolute deviation algorithm with a modified z-score threshold of 40 to remove outliers from the value added metrics. This may involve calculating the median absolute deviation of the value added metrics, calculating the modified z-score for each value added metric, and removing value added metrics that have a modified z-score above the threshold. This may help to ensure that the value added metrics are not unduly influenced by extreme values or outliers.

In some aspects, the method may involve determining a validation condition for each group of decisions based on the decision type and the episode data. In an aspect, the validation condition may be a criterion or set of criteria used to check availability of data for accurate calculations. For example, the validation condition for entry timing decisions may be that the holdings data comprises sufficient entries after the entry decision in the given time window.

In some embodiments, the value added metrics may be calculated for the decisions. This may involve applying a mathematical formula or algorithm to the episode data to calculate the value added by each decision. In some aspects, the method may involve training a machine learning algorithm to calculate the value added metrics based on the decision type and the episode data. The machine learning algorithm may determine a mathematical formula suitable for calculating the value added metrics based on number of entries in the episode data.

In some aspects, the machine learning algorithm may be trained using supervised training using training data comprising a plurality of episode data for a plurality of portfolio managers, annotations for selected mathematical formulae for respective decision types in the plurality of episode data. Further, the machine learning algorithm may be re-trained using reinforcement learning based on feedback comprising annotations for decision types with insufficient entries, and corrected annotations for the selected mathematical formulae.

The re-trained machine learning model may choose to skip a decision type for the calculation of value added metrics when the number of entries in the episode data for the decision type are not sufficient. The value added metrics calculated for decision types with insufficient entries may not be accurate thereby causing errors in calculations.

In some aspects, the method involves calculating a variety of value added metrics for the decisions, each corresponding to a different aspect of the portfolio manager's decision-making process. These value added metrics may include value added percentage, value added percentage compounding, general impact compounding, and weighting impact compounding. Each of these metrics provides a different perspective on the economic value added by the portfolio manager's decisions, and together they contribute to a comprehensive and nuanced measure of the portfolio manager's decision-making skill.

In some embodiments, the method may involve identifying suitable value added metrics for the decisions based on the decision type. In some aspects the suitable value added metrics may be determined using a rule based system. In other aspects the suitable value added metrics may be determined using a machine learning algorithm trained using reinforcement learning.

The machine learning algorithm may be continuously trained using feedback received from a user. The feedback may comprise corrections or additions corresponding to the suitable value added metrics selected for a decision type in the holdings data. The machine learning algorithm may learn patterns to connect one or more characteristics about the holdings data, decision types, and the suitable value added metrics. The continuous training of the machine learning algorithm ensures high accuracy for determining the suitable value added metrics.

In an aspect, the machine learning algorithm may predict the value added metrics based on a portion of entries in the decision type and the benchmark. The machine learning algorithm may be trained using a set of entries for the decision types, and the calculated value added metrics for the decision types for the set of entries. The machine learning algorithm may learn to identify a pattern in the entries to predict the value added metrics based on a plurality of test simulations using testing data comprising new entries for the decision types. Further, the machine learning algorithm may be retrained using reinforcement learning based on feedback comprising corrections corresponding to the portion of entries selected for prediction, and the predicted value added metrics.

In some cases, the value added percentage may be calculated for each decision relative to a benchmark, over a specified time period, using the relative version of the episode data. The benchmark may be a market index or other reference point relevant to the strategy of the underlying portfolio. By comparing the episode to the benchmark, the value added percentage provides a measure of the economic value added by the portfolio manager's decision, beyond what would have been possible by simply investing in the benchmark.

In some embodiments, the value added percentage compounding may be calculated for stock-picking decisions. This metric uses the time-weighted rate of return of an investment to quantify the compounded impact of the portfolio manager's stock-picking decisions. The time-weighted rate of return eliminates the effect of the timing and magnitude of cash flows into and out of the investment, providing a more accurate measure of the portfolio manager's skill in selecting profitable stocks.

In some aspects, the general impact compounding may be calculated for size adjusting decisions. This metric quantifies the compounded impact of the portfolio manager's decisions to add or trim positions, compared to a hypothetical scenario where the portfolio manager simply held a constant position. By comparing the actual performance of the portfolio with this hypothetical scenario, the general impact compounding provides a measure of the economic value added by the portfolio manager's size adjusting decisions.

In some cases, the weighting impact compounding may be calculated for weighting decisions. This metric compares the actual allocation of capital to each instrument in the portfolio with a hypothetical equally-weighted position in the portfolio. The hypothetical equally-weighted portfolio represents a default allocation strategy where each instrument in the portfolio is given an equal share of the portfolio's capital. By comparing the actual allocation of capital with this default strategy, the weighting impact compounding provides a measure of the economic value added by the portfolio manager's weighting decisions.

In some embodiments, these value added metrics may be calculated using a variety of mathematical formulas or algorithms, depending on the specific requirements of the task. The calculated value added metrics may then be used to calculate decision metrics including behavioral alpha (BA) score for the portfolio manager, providing a comprehensive and nuanced measure of the portfolio manager's decision-making skill.

In some aspects, the method involves calculating decision metrics for the one or more decisions. These decision metrics may include hit-rate, payoff, and the BA score, each of which provides a different perspective on the portfolio manager's decision-making skill.

The hit-rate may be calculated as the proportion of all decisions that have a positive value-added. This metric provides a measure of the frequency with which the portfolio manager's decisions result in a positive economic outcome. A high hit-rate may indicate that the portfolio manager is consistently able to make decisions that add value to the portfolio.

The payoff may be calculated as the ratio of the average value-added for decisions that have a positive value-added to the average value-added for decisions that have a negative value-added. This metric provides a measure of the magnitude of the economic value added by the portfolio manager's decisions. A high payoff may indicate that the portfolio manager's decisions not only add value to the portfolio, but do so to a significant degree.

The BA score may be calculated based on a combination of the hit-rate and the payoff. This score provides a comprehensive measure of the portfolio manager's decision-making skill, taking into account both the frequency and the magnitude of the economic value added by their decisions. A high BA score may indicate that the portfolio manager is both consistently able to make decisions that add value to the portfolio and able to do so to a significant degree.

In some cases, aggregate decision metrics may be calculated for each decision type separately. This may allow for a more detailed and granular analysis of the portfolio manager's decision-making skill across different phases of the investment process. For example, the decision metrics may be calculated separately for entry timing decisions, scaling in decisions, stock-picking decisions, size adjusting decisions, weighting decisions, scaling out decisions, and exit timing decisions. This may reveal specific areas of strength and weakness in the portfolio manager's decision-making process.

In some embodiments, the decision metrics may be calculated using a variety of mathematical formulas or algorithms, depending on the specific requirements of the task. The calculated decision metrics may then be used to calculate the BA Score for the portfolio manager, providing a comprehensive and nuanced measure of the portfolio manager's decision-making skill.

In some aspects, the method comprises detecting an outlier decision type. The decisions of the decision type having an anomalous value added metric may not be considered for the calculation of the decision metrics. In some cases, the decision metrics, including hit-rate, payoff, and BA score, are only calculated if the episode data has sufficient entries or data points. For example, the method may require that every decision type at this stage have at least 240 decisions or entries to undergo the final calculations. This requirement may help to ensure that the BA score is based on a robust and representative sample of decisions, thereby enhancing the reliability and accuracy of the score.

In some aspects, the method involves generating a final unbiased rank for a portfolio manager based on the calculated decision metrics. The final rank may be a numerical score or a relative ranking that reflects the portfolio manager's overall decision-making skill as measured by the BA Score. The final rank may be used to compare and rank different portfolio managers, providing a basis for investment decisions, performance evaluations, or other purposes.

In some cases, the final rank may be generated by aggregating the value added metrics for each decision type. This may involve calculating pooled decision metrics, with the pooling reflecting the value add metrics from all episodes and decision types in the same aggregation.

In some embodiments, the final rank may be normalized to a standard scale, such as a scale from 0 to 100, to facilitate comparison between different portfolio managers. The normalization process may involve scaling the aggregated decision metrics based on the maximum and minimum possible values, or using other normalization techniques.

In other cases, the final rank may be adjusted based on additional factors, such as the portfolio manager's experience, the size of the portfolio, the volatility of the market, or other relevant factors. These adjustments may help to account for differences in the investment environment or the portfolio manager's circumstances that could affect their decision-making skill.

In some aspects, the final rank may be presented in a user-friendly format, such as a graphical representation or a numerical score, to facilitate interpretation and use by investors, capital allocators, or other users. The presentation may also include additional information, such as a breakdown of the decision metrics for each decision type, to provide a more detailed view of the portfolio manager's decision-making skill.

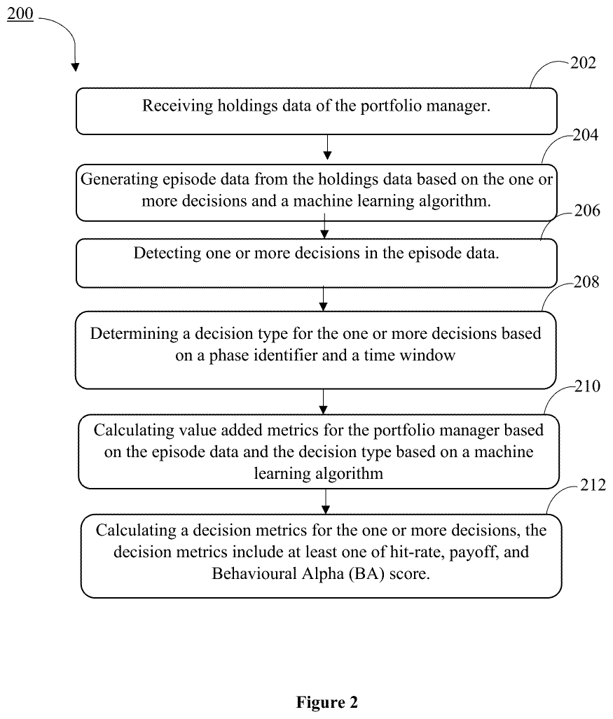

Referring to FIG. 2, a flowchart for a method 200 of generating an unbiased rank for a portfolio manager is illustrated. The method 200 begins with step 202, where holdings data of the portfolio manager is received. The holdings data may include information about the portfolio manager's investment decisions, such as the securities or instruments bought or sold, the quantity of each security, the timing of each transaction, and other relevant data. This data may be collected from various sources, such as trading platforms, brokerage accounts, or directly from the portfolio manager.

In step 204, episode data is generated from the holdings data based on a machine learning algorithm. An episode may represent a period of time during which a specific security is held in the portfolio, from the initial purchase to the final sale. The episode data may include information about the decisions made during the episode, the performance of the security, and other relevant data.

Following the detection of decisions, the method 200 proceeds to step 206, where one or more decisions are detected in the episode data. These decisions may correspond to changes in the quantity of an instrument in the portfolio, such as buying or selling a security. The detection of decisions may be performed using a machine learning algorithm, which can analyze the holdings data and identify patterns or changes that indicate a decision.

In step 208, a decision type for the one or more decisions is determined based on a phase identifier and a time window. The phase identifier may categorize the decisions into different types, such as entry timing, exit timing, scaling in, scaling out, size adjusting, weighting, and stock picking. The time window may define a period of time during which the decision is considered for analysis.

In step 210, value added metrics for the portfolio manager are calculated based on the episode data and the decision type using a machine learning algorithm. The value added metrics may quantify the portfolio manager's ability to make effective decisions for different decision types.

Finally, step 212 involves calculating decision metrics for the one or more decisions. The decision metrics may include the hit rate, which measures the proportion of decisions that resulted in a positive outcome, the payoff, which measures the return on investment from the decisions, and the BA score, which may be a composite score based on the value added metrics, the hit rate, and the payoff.

In some cases, the method 200 may provide a comprehensive and unbiased evaluation of a portfolio manager's decision-making skill. By focusing on the quality of individual decisions rather than overall portfolio performance, the method 200 may offer a more accurate and nuanced assessment of a portfolio manager's abilities. Furthermore, by leveraging machine learning algorithms, the method 200 may efficiently process large amounts of data and generate insightful metrics.

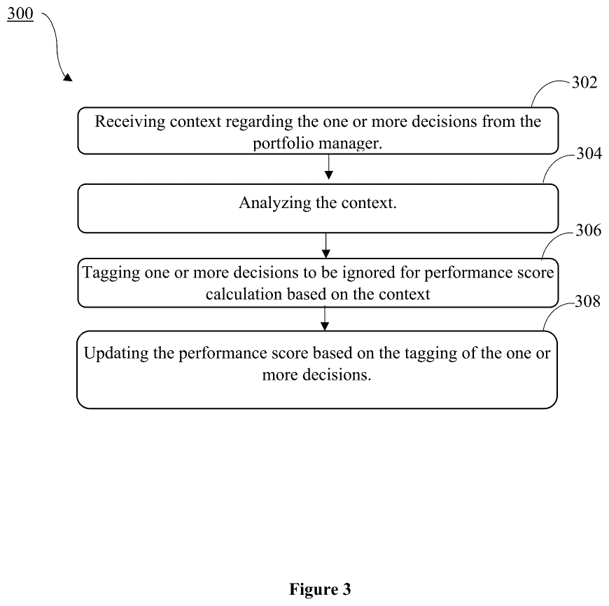

Referring to FIG. 3, a flowchart for a method 300 of updating a portfolio manager's BA score is illustrated. The method 300 begins with step 302, where context regarding one or more decisions from the portfolio manager is received. The context may include additional information or considerations that influenced the portfolio manager's decisions, such as portfolio inflows and outflows, market conditions, investment strategy, risk tolerance, or other factors. This context may be provided by the portfolio manager or derived from other data sources.

In step 304, the received context is analyzed. This analysis may involve processing the context data using a machine learning algorithm or other data analysis techniques. The analysis may aim to identify patterns, trends, or correlations in the context data that may be relevant to the portfolio manager's decision-making process.

Following the analysis, the method 300 moves to step 306, where one or more decisions are tagged to be ignored for BA score calculation based on the analyzed context. This step allows for the exclusion of certain decisions from the BA score calculation if the context indicates that these decisions were influenced by exceptional circumstances or factors outside the portfolio manager's control. The tagging may be performed using a machine learning algorithm or other data processing techniques.

The method 300 concludes with step 308, where the BA score is updated based on the tagging of the one or more decisions. The updated BA score reflects the portfolio manager's decision-making skill, taking into account the context of the decisions. The BA score may be calculated using various metrics, such as hit rate, payoff, and other performance indicators.

In some aspects, the method 300 provides a more nuanced evaluation of a portfolio manager's performance by incorporating contextual information into the BA score calculation. This approach allows for a more accurate assessment of the portfolio manager's decision-making skill, as it takes into account the specific circumstances and considerations that influenced the portfolio manager's decisions. By selectively excluding certain decisions from the BA score calculation based on context, the method 300 can provide a more fair and unbiased evaluation of the portfolio manager's performance.

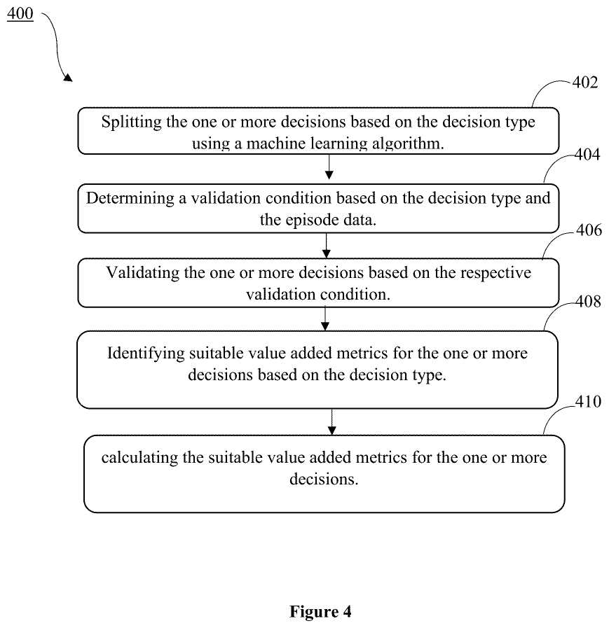

Referring to FIG. 4, a flowchart for a method 400 of calculating value added metrics for investment decisions is illustrated. The method 400 begins with step 402, which involves splitting one or more decisions based on the decision type using a machine learning algorithm. The decision types may include entry timing, exit timing, scaling in, scaling out, size adjusting, weighting, and stock picking. The machine learning algorithm may analyze the holdings data and identify patterns or changes that indicate a decision type. In step 404, a validation condition is determined based on the decision type and the episode data. The validation condition may specify certain criteria or thresholds that the decisions must meet to be considered valid for further analysis. For example, the validation condition may require that the decisions fall within a certain range of values, occur within a specific time window, or the episode data may comprise a sufficient number of entries.

Following the determination of the validation condition, the method 400 moves to step 406, where the one or more decisions are validated based on the respective validation condition. This step may involve checking each decision against the validation condition and excluding any decisions that do not meet the condition. The validation process may help to ensure that the subsequent analysis and calculations are based on relevant and meaningful decisions.

In step 408, suitable value added metrics are identified for the one or more decisions based on the decision type. The value added metrics may quantify the impact or effectiveness of the decisions in terms of their contribution to the portfolio's performance. The metrics may vary depending on the decision type, reflecting the different ways in which different types of decisions can influence the portfolio's performance.

Finally, in step 410, the suitable value added metrics are calculated for the one or more decisions. The calculation may involve various mathematical operations or statistical methods, and may take into account various factors such as the timing of the decisions, the quantities of securities involved, the prices of the securities, and other relevant data. The calculated value added metrics may provide a quantitative measure of the portfolio manager's decision-making skill, offering a more objective and nuanced assessment than traditional performance metrics.

In some aspects, the method may comprise excluding decisions from an entire decision type from further calculations in case the value added metrics calculated for the decision type are anomalous.

In some aspects, the method 400 provides a comprehensive and unbiased evaluation of a portfolio manager's decision-making skill. By focusing on the quality of individual decisions rather than overall portfolio performance, the method 400 may offer a more accurate and nuanced assessment of a portfolio manager's abilities. Furthermore, by leveraging machine learning algorithms, the method 400 may efficiently process large amounts of data and generate insightful metrics.

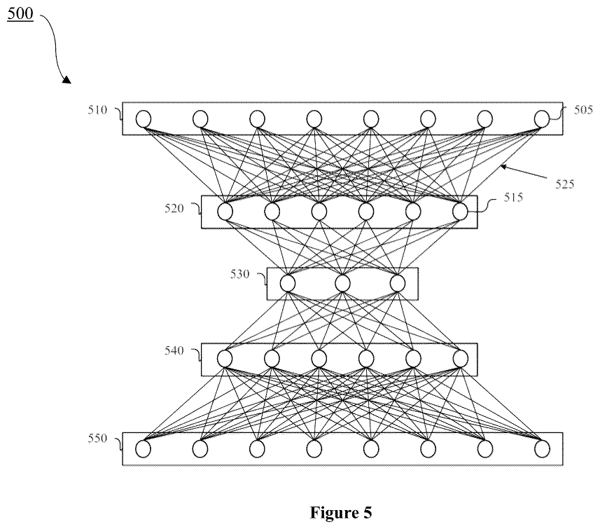

Referring to FIG. 5, a system diagram 500 of a neural network architecture is illustrated. The system diagram 500 represents a neural network model that may be used to process and transform input data for generating unbiased portfolio manager rankings. The neural network architecture includes multiple layers, each designed to perform specific functions in the data processing pipeline.

In some aspects, the system diagram 500 begins with an input layer 505, which contains input nodes 510. The input layer 505 receives the initial data for processing. This data may include various features or attributes related to the portfolio manager's decisions, such as the timing of the decisions, the quantities of securities involved, the prices of the securities, and other relevant data.

Connected to the input layer 505 is a hidden layer 515, which consists of hidden nodes 520. The hidden layer 515 performs intermediate computations and feature extraction. It may apply various transformations to the input data, such as linear or non-linear transformations, to extract meaningful features or patterns from the data. The hidden layer 515 may include multiple layers of hidden nodes 520, each performing different transformations on the data.

The system diagram 500 also includes a bottleneck layer 530, which contains fewer nodes than the preceding layers. The bottleneck layer 530 serves to reduce the dimensionality of the data, capturing the essential features of the data in a compressed form. This layer may help in simplifying the data representation, making the subsequent processing steps more efficient and manageable.

Following the bottleneck layer 530 is an output layer 540, which contains output nodes 550. The output layer 540 produces the final output of the neural network based on the processed information from the previous layers. The output may represent the calculated decision metrics for the portfolio manager, providing a quantitative measure of the manager's decision-making skill.

The connections 525 link the nodes between layers, representing the flow of information and the weights applied during processing. These connections 525 are shown as lines connecting nodes across different layers. The weights associated with these connections 525 may be adjusted during the training process of the neural network, allowing the network to learn and adapt to the data.

In some cases, the neural network architecture depicted in the system diagram 500 may provide a powerful tool for analyzing portfolio manager decisions and generating performance metrics. By leveraging the capabilities of neural networks, the system can efficiently process large amounts of data, extract meaningful features, and generate insightful metrics that provide a more accurate and nuanced assessment of a portfolio manager's decision-making abilities.

FIG. 5 illustrates an example artificial neural network (“ANN”) 500 of the machine learning algorithms and models described above. In particular embodiments, an ANN may refer to a computational model comprising one or more nodes. Example ANN 500 may comprise an input layer 510, hidden layers 520, 530, 540, and an output layer 550. Each layer of the ANN 500 may comprise one or more nodes, such as a node 505 or a node 515. In particular embodiments, each node of an ANN may be connected to another node of the ANN. As an example, and not by way of limitation, each node of the input layer 510 may be connected to one of more nodes of the hidden layer 520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 5 depicts a particular ANN with a particular number of layers, a particular number of nodes, and particular connections between nodes, this disclosure contemplates any suitable ANN with any suitable number of layers, any suitable number of nodes, and any suitable connections between nodes. As an example, and not by way of limitation, although FIG. 5 depicts a connection between each node of the input layer 510 and each node of the hidden layer 520, one or more nodes of the input layer 510 may not be connected to one or more nodes of the hidden layer 520.

In particular embodiments, an ANN may be a feedforward ANN (e.g., an ANN with no cycles or loops where communication between nodes flows in one direction beginning with the input layer and proceeding to successive layers). As an example, and not by way of limitation, the input to each node of the hidden layer 520 may comprise the output of one or more nodes of the input layer 510. As another example and not by way of limitation, the input to each node of the output layer 550 may comprise the output of one or more nodes of the hidden layer 540. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example, and not by way of limitation, the input into residual block N may be F(x)+x, where F(x) may be the output of residual block N-1, x may be the input into residual block N-1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example, and not by way of limitation, an activation function may be an identity function, a binary step function, a logistic function, or any other suitable function.

In particular embodiments, the input of an activation function corresponding to a node may be weighted. Each node may generate output using a corresponding activation function based on weighted inputs. In particular embodiments, each connection between nodes may be associated with a weight. As an example, and not by way of limitation, a connection 525 between the node 505 and the node 515 may have a weighting coefficient of 0.4, which may indicate that 0.4 multiplied by the output of the node 505 is used as an input to the node 515. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, the ANN may be trained using training data. As an example, and not by way of limitation, training data may comprise inputs to the ANN 500 and an expected output. As another example and not by way of limitation, training data may comprise vectors each representing a training object and an expected label for each training object. In particular embodiments, training the ANN may comprise modifying the weights associated with the connections between nodes of the ANN by optimizing an objective function. As an example, and not by way of limitation, a training method may be used (e.g., the conjugate gradient method, the gradient descent method, the stochastic gradient descent) to backpropagate the sum-of-squares error measured as a distance between each vector representing a training object (e.g., using a cost function that minimizes the sum-of-squares error). In particular embodiments, the ANN may be trained using a dropout technique. As an example, and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training the ANN in a particular manner, this disclosure contemplates training the ANN in any suitable manner.

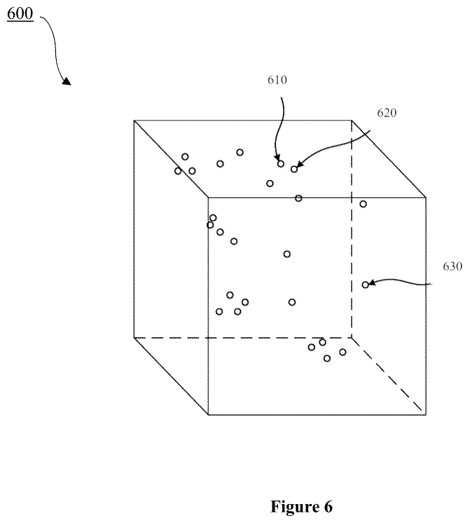

Referring to FIG. 6, a three-dimensional representation of decision data is depicted. This representation may visualize portfolio manager decisions and their impacts in a multi-dimensional space. The three-dimensional space, represented as a cube structure 600, may be defined by three axes, each representing a different parameter or dimension used in analyzing portfolio manager decisions. These parameters or dimensions may include, for example, the type of decision, the impact of the decision on portfolio value, and the timing of the decision.

In some aspects, each point within the cube structure 600 may represent a vector (610, 620, and 630) of one or more decisions made by the portfolio manager. The position of each point within the cube structure 600 may be determined based on the values of the parameters or dimensions for that decision. For example, a point located near the top front edge of the cube structure 600, represented as point 610, may represent a decision that had a high impact on portfolio value, was made early in the time period covered by the data, and corresponds to a particular decision type.

In some cases, the three-dimensional representation of decision data may provide a visual way to explore and understand the relationships between different decisions and their impacts on portfolio value. For example, the portfolio manager or other users may be able to visually identify clusters of decisions that had similar impacts on portfolio value, were made at similar times, or correspond to the same decision type. This visual representation may aid in the analysis of portfolio manager decisions and may provide insights that could be used to improve future decision-making.

In some aspects, the three-dimensional representation of decision data may be generated using a machine learning algorithm. The machine learning algorithm may be trained on a variety of data, including historical holding data, decision data, and other relevant information. This approach may allow the machine learning algorithm to accurately position each decision within the cube structure 600 based on the values of the parameters or dimensions for that decision.

In some cases, the three-dimensional representation of decision data may be interactive, allowing the portfolio manager or other users to rotate the cube structure 600, zoom in or out, select individual points to view more detailed information about the corresponding decisions, or perform other interactive operations. This interactivity may enhance the usability of the three-dimensional representation and may provide a more engaging and informative way to explore and understand portfolio manager decisions and their impacts.

In some cases, the cube structure 600 provides a visual tool for multidimensional analysis of portfolio data, enabling a more nuanced and comprehensive evaluation of a portfolio manager's decision-making skill. By representing the portfolio data in three dimensions, the data cube 600 allows for the exploration of complex relationships and patterns among the data points 610, offering deeper insights into the portfolio manager's performance.

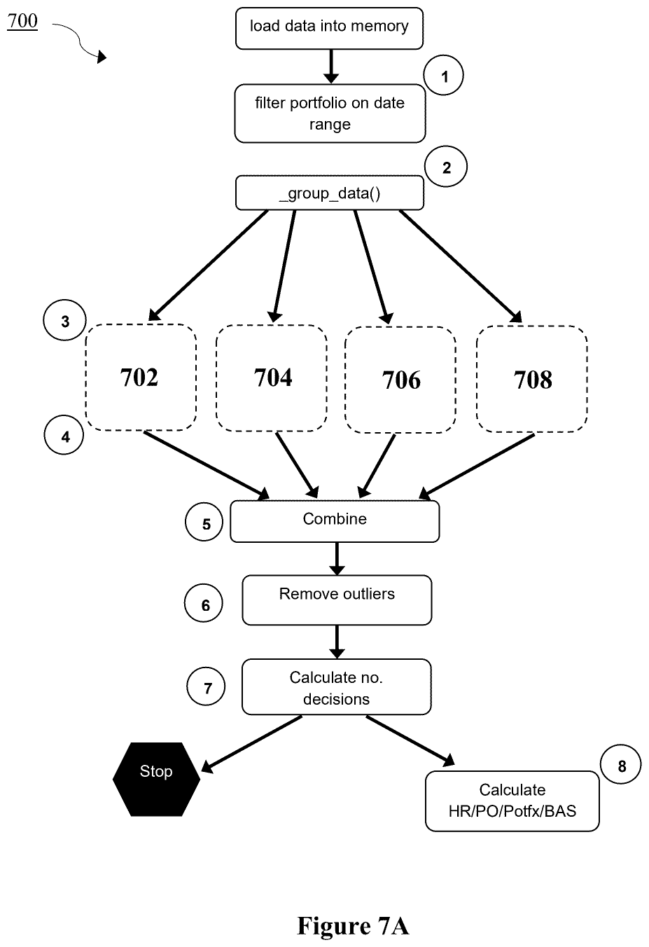

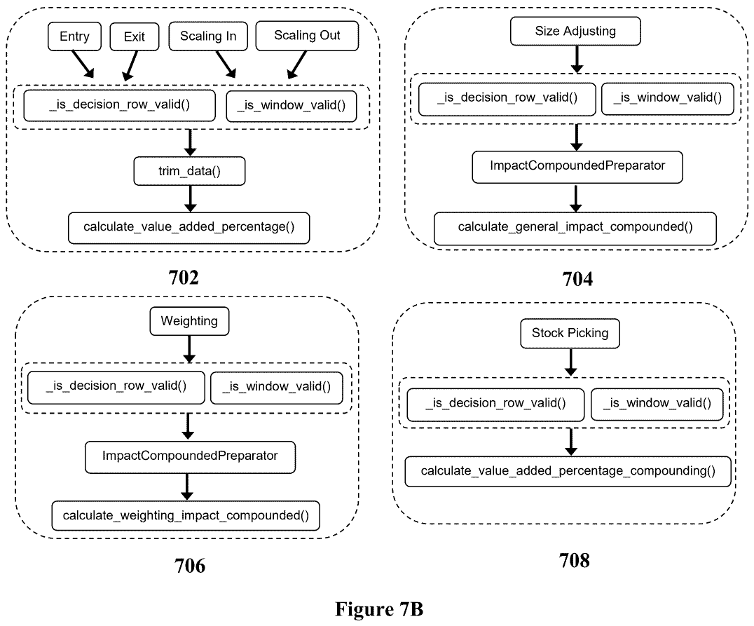

Referring to FIG. 7A, a flowchart for a method 1 of processing and analyzing portfolio data is illustrated. The method 1 provides a structured approach for generating unbiased portfolio manager rankings based on the quality of individual investment decisions. The method 1 involves several key steps and decision types, each contributing to the overall evaluation of a portfolio manager's decision-making skill.

The method 1 begins with loading data into memory. This data may include various features or attributes related to the portfolio manager's decisions, such as the timing of the decisions, the quantities of securities involved, the prices of the securities, and other relevant data.

In step 2, the portfolio is filtered on a date range. This step may involve selecting a specific period of time for analysis, such as the past three years or twelve quarters. The selected date range may be based on various factors, such as the availability of data, the portfolio manager's investment strategy, or other considerations.

Referring to FIGS. 7A and 7B, the flowchart following the filtering of the portfolio in method 1 proceeds to step 3, where the data is grouped into different decision types (702, 704, 706, 708). These decision types may include Entry, Exit, Scaling In, Scaling Out (702), Size Adjusting (704), Weighting (706), and Stock Picking (708). Each decision type represents a specific type of investment decision that the portfolio manager makes, and each may contribute differently to the portfolio's performance.

For each decision type, the method 1 performs validation checks in step 4. These validation checks may involve verifying that the decisions meet certain criteria or thresholds to be considered valid for further analysis. For example, the validation checks for Entry, Exit, Scaling In, and Scaling Out decisions (702) may involve verifying that the decisions occurred within a specific time window and that the decisions resulted in a change in the quantity of a security in the portfolio.

Referring to FIG. 7A again, once the decisions have been validated, the method 1 moves to step 5, where the results from all decision types are combined. This step may involve aggregating the data from all decision types into a single dataset, allowing for a comprehensive analysis of the portfolio manager's decision-making skill.

In step 6, outliers are removed from the combined data. This step may involve identifying and excluding data points that fall outside a certain range or that deviate significantly from the overall pattern of the data. Removing outliers can help to ensure that the final calculations are based on relevant and meaningful decisions.

The method 1 then calculates the number of decisions in step 7. If the number of decisions meets a certain threshold, the method 1 proceeds to step 8, where it calculates HR/PO/PO/BAS (presumably Hit Rate, Payoff, and other metrics). If the threshold is not met, the method 1 stops. This step ensures that the final calculations are based on a sufficient number of decisions to provide a reliable and meaningful evaluation of the portfolio manager's decision-making skill.

In some aspects, the method 1 provides a comprehensive and unbiased evaluation of a portfolio manager's decision-making skill. By focusing on the quality of individual decisions rather than overall portfolio performance, the method 1 may offer a more accurate and nuanced assessment of a portfolio manager's abilities. Furthermore, by leveraging machine learning algorithms, the method 1 may efficiently process large amounts of data and generate insightful metrics.

A number of implementations have been described. Nevertheless, it will be understood that various modifications may be made without departing from the spirit and scope of the disclosure. Accordingly, other implementations are within the scope of the following claims.

1. A computer-implemented method for processing decision data with reduced computational load, comprising:
receiving portfolio manager decision data, wherein the decision data comprises identified decisions and corresponding decision types;
mapping, each decision, from the decision data, to coordinates in a three-axis space defined by decision type, timing window, and impact, and forming corresponding vectors;
supplying the vectors to an artificial-neural-network (ANN) having an input layer that receives the vectors, one or more hidden layers that transform the vectors, and a bottleneck layer with fewer nodes than a preceding hidden layer that reduces a dimensionality of the transformed vectors to produce a compressed representation of the transformed vectors, and an output layer; determining, using the compressed representation, a validation condition for each decision type based on the timing window and decision entries and identifying decisions that satisfy the validation condition;
for identified decisions, computing, using the compressed representation, a median absolute deviation and a modified z-score, and discarding a first set of decisions having a modified z-score greater than a threshold z-score to obtain remaining set of decisions;
after discarding a first set of decisions, determining, for each decision type, whether a count of the remaining set of decisions is greater than a threshold decision count;
from the remaining set of decisions, omitting decisions of the decision type having the decision count under the threshold decision count to obtain final set of decision to avoid inaccuracy due to sparse data;
for the final set of decision, computing one or more decision metrics, using the compressed representation, the computing comprises comparisons to baseline alternatives comprising an equally-weighted alternative, a linear-increase alternative, and a median-quantity alternative;
aggregating the one or more decision metrics to generate a portfolio-manager score; and
outputting the portfolio manager score.

2. The method of claim 1, wherein the decision type is selected from a group consisting of entry timing, scaling in, stock picking, size adjusting, weighting, scaling out, and exit timing.

3. The method of claim 1, wherein calculating the value added metrics comprises:
splitting, by the processor, the one or more decisions based on the decision type using a machine learning algorithm;
determining, by the processor, a validation condition based on the decision type and the episode data;
validating, by the processor, the one or more decisions based on the respective validation condition;
identifying, by the processor, suitable value added metrics for the one or more decisions based on the decision type; and
calculating, by the processor, the suitable value added metrics for the one or more decisions.

4. The method of claim 3, wherein the decision type is selected from a group consisting of entry, exit, scaling in, scaling out, size adjusting, stock picking, and weighting.

5. The method of claim 3, wherein the validation condition includes at least one of a valid start date and sufficient data within a subset.

6. The method of claim 3, wherein the suitable value added metrics include at least one of value added percentage, value added percentage compounding, general impact compounding, and weighting impact compounding.

7. The method of claim 1, further comprising updating the decision metrics based on contextual information received regarding one or more of the decisions.

8. The method of claim 1, wherein the machine learning algorithm used for detecting decisions is a supervised learning algorithm trained on historical portfolio data.

9. The method of claim 1, wherein generating episode data comprises identifying a period from when a quantity of an instrument is first acquired to when the quantity becomes zero.

10. The method of claim 1, wherein the phase identifier categorizes decisions into different phases of an investment episode.

11. The method of claim 10, wherein the phases include at least two of entry, scaling in, size adjusting, scaling out, and exit.

12. The method of claim 1, wherein the time window defines a period for analyzing the impact of a decision.

13. The method of claim 1, wherein calculating the value added metrics comprises comparing the portfolio manager's decisions to a hypothetical alternative decision.

14. The method of claim 13, wherein the hypothetical alternative decision is based on an equally weighted portfolio for weighting decisions.

15. The method of claim 1, further comprising generating a ranking of multiple portfolio managers based on their respective decision metrics.

16. The method of claim 1, wherein the hit-rate represents a proportion of decisions that resulted in a positive outcome.

17. The method of claim 1, wherein the payoff represents a magnitude of return on investment from the decisions.

18. A system for processing decision data with reduced computational load, comprising:
a processor; and
a memory storing instructions that, when executed by the processor, cause the system to:
receive portfolio manager decision data, wherein the decision data comprises identified decisions and corresponding decision types;
map each decision, from the decision data, to coordinates in a three axis space defined by decision type, timing window, and impact, and forming corresponding vectors;
supply the vectors to an artificial-neural-network (ANN) having an input layer that receives the vectors, one or more hidden layers that transform the vectors, a bottleneck layer with fewer nodes than a preceding hidden layer that reduces a dimensionality of the transformed vectors to produce a compressed representation of the transformed vectors, and an output layer;
determine, using the compressed representation, a validation condition for each decision type based on the timing window and decision entries and identifying decisions that satisfy the validation condition;
for identified decisions, compute, using the compressed representation, a median absolute deviation and a modified z-score, and discarding a first set of decisions having a modified z-score greater than a threshold z-score to obtain remaining set of decisions;
after discarding a first set of decisions, determine, for each decision type, whether a count of the remaining set of decisions is greater than a threshold decision count;
from the remaining set of decisions, omit decisions of the decision type having the decision count under the threshold decision count to obtain final set of decision to avoid inaccuracy due to sparse data;
for the final set of decision, compute one or more decision metrics, using the compressed representation, by using comparisons to baseline alternatives comprising an equally-weighted alternative, a linear-increase alternative, and a median-quantity alternative;
aggregate the one or more decision metrics to generate a portfolio-manager score; and
outputting the portfolio manager score.
